(19) United States
(12) Patent Application Publication
(10) Pub. No.: US 2015/0368495 A1
(43) Pub. Date: Dec. 24, 2015

(54) COMPOSTIONS FOR REPAIRING ELECTRICAL SIGNAL-CARRYING CABLES

(71) Applicant: E. I. DU PONT DE NEMOURS AND COMPANY, Wilmington, DE (US)

(72) Inventors: DANIEL A. FAVEREAU, CHAMBESY (CH); LUK GERMAIN PIERRE JOSEPH D'HAENENS, GENT (BE); CLAES GUSTAV JANNERFELDT, ARZIER (CH); CHRISTOPHE PODWIKA, GERGY (FR)

(21) Appl. No.: 14/410,262

(22) PCT Filed: Jun. 26, 2013
(86) PCT No.: PCT/US2013/047739

§ 371 Date: Dec. 22, 2014

Related U.S. Application Data
(60) Provisional application No. 61/664,232, filed on Jun. 26, 2012.

(51) Int. Cl. C09D 127/20; H01B 13/18; H01B 13/30; C09D 127/18

(52) U.S. Cl. CPC C09D 127/20; C09D 127/18; H01B 13/18; H01B 13/30

(57) ABSTRACT

The present invention provides for a liquid composition for repairing the fluoropolymer insulating sheath of electrical signal-carrying cables, and comprises at least one amorphous fluoropolymer, at least one amorphous perfluoroalkylether and at least one fluorinated solvent. The present invention further provides for a process for repairing an electrically insulating fluoropolymer sheath of an electrical signal-carrying cable, comprising depositing such a liquid composition on at least a damaged area of the fluoropolymer electrically insulating sheath to form at least one layer of liquid composition and evaporating the fluorinated solvent to solidify the liquid composition, as well as the electrical signal-carrying cable obtainable by this process.

### FIELD OF THE INVENTION

The present invention relates to compositions for repairing damaged sheathing of fluoropolymer sheathed electrical signal-carrying cables.

### BACKGROUND OF THE INVENTION

With the advent of fly-by-wire technology in commercial aircraft and the increased importance of avionics, the amount of electrical cabling and wire in aircraft has been steadily rising.

For example, many aircraft contain bundles of cables which would stretch over several kilometers if fully extended. By binding the many cables into one or more cable harnesses, such cables can be better secured against the adverse effects of vibration, abrasion, and moisture. By constricting the cables into a non-flexing bundle, usage of space is optimized, and the risk of a short-circuit is decreased. Since the installer has only one harness to install (as opposed to a multitude of cables), installation time is decreased and thus manufacturing cost reduced.

However, wires and/or cables may be damaged during harness production or installation phases.

For instance, when installing a wire harness by drawing the cables through a constricted space in the fuselage of the aircraft, it may happen that a salient or sharp metal part of the fuselage damages one of the cables by shaving off part of the insulation or by repeated abrasion and/or crimping of the cable.

While it is possible to remove and replace such a damaged cables in a cable harness, it is preferable to repair such cable in situ when possible, since removal and replacement of the damaged cable will delay the assembly of the aircraft and increase the cost of manufacturing thereof. The same reasoning applies to maintenance operations.

It is therefore highly desirable to re-establish the properties of the damaged insulation in an efficient and economical way to reduce the risk of short-circuiting in a damaged cable, as well as to prevent a worsening of the mechanical damage to the insulation and the conductor.

### SUMMARY OF THE INVENTION

The present invention provides for a liquid composition for repairing the insulating fluoropolymer sheath of electrical signal-carrying cables, the liquid composition comprising at least one amorphous fluoropolymer, at least one amorphous perfluoroalkylether and at least one fluorinated solvent. The present invention also provides for the use of said composition.

The present invention also provides for an electrical signal-carrying cable comprising the liquid composition according to the above.

The present invention further provides for a process for repairing an electrically insulating sheath of an electrical signal-carrying cable, comprising the steps of, in this order, depositing a liquid composition according to the above on at least a damaged area of the electrically insulating sheath to form at least one layer of liquid composition and evaporating the fluorinated solvent to solidify the liquid composition, as well as the electrical signal-carrying cable obtainable by said process.

The present invention further provides for a process for repairing an electrically insulating sheath of an electrical signal-carrying cable, comprising the steps of, in this order, depositing a liquid composition according to the above on at least a damaged area of the electrically insulating sheath to form at least one layer of liquid composition thereon, depositing at least one layer of unsintered polytetrafluoroethylene (PTFE) on at least the damaged area of the electrically insulating sheath, and evaporating the fluorinated solvent to solidify the liquid composition, as well as the electrical signal-carrying cable obtainable by said process.

The present invention alternatively provides for a process for repairing an electrically insulating sheath of an electrical signal-carrying cable, comprising the steps of, in this order, depositing a liquid composition according the above on at least a damaged area of the electrically insulating sheath to form at least one layer of liquid composition thereon, depositing at least one layer of unsintered polytetrafluoroethylene (PTFE) on at least the damaged area of the electrically insulating sheath, and evaporating the fluorinated solvent to solidify the liquid composition, as well as the electrical signal-carrying cable obtainable by said process.

The present invention additionally provides for a pre-impregnated unsintered polytetrafluoroethylene (PTFE) tape or film for repairing the insulating sheath of electrical signal-carrying cables comprising unsintered polytetrafluoroethylene (PTFE) and a liquid composition according to the above.

The present invention additionally provides for a process for repairing an electrically insulating sheath of an electrical signal-carrying cable, comprising the steps of, in this order, depositing a pre-impregnated unsintered polytetrafluoroethylene (PTFE) tape or film according to the above, on at least a damaged area of the electrically insulating sheath, and evaporating the fluorinated solvent to solidify the liquid composition.

### DETAILED DESCRIPTION

In the light of the present disclosure, the term “(hydro)fluorocarbons” refers to both hydrofluorocarbons and perfluorocarbons.

The present invention provides for a liquid composition for repairing the insulating sheath of electrical signal-carrying cables comprising at least one amorphous fluoropolymer, at least one amorphous perfluoroalkylether and at least one fluorinated solvent.

The liquid composition for repairing the insulating sheath of electrical signal-carrying cables according to the present invention can comprise of from 1 to 30 weight percent, preferably of from 5 to 18 weight percent, of amorphous fluoropolymer, based on the total weight of the composition.

The liquid composition for repairing the insulating sheath of electrical signal-carrying cables according to the present invention can comprise of from 1 to 45 weight percent, preferably of from 5 to 27 weight percent of amorphous perfluoroalkylether, based on the total weight of the composition.

The liquid composition for repairing the insulating sheath of electrical signal-carrying cables according to the present invention can comprise of from 25 to 98 weight percent, preferably of from 55 to 90 weight percent of fluorinated solvent, based on the total weight of the composition.

Preferably, the liquid composition for repairing the insulating sheath of electrical signal-carrying cables according to the present invention comprises amorphous fluoropolymer and amorphous perfluoroalkylether in a weight ratio of from 3/2 to 2/3.

The amorphous fluoropolymer may be chosen among amorphous copolymers of tetrafluoroethylene, amorphous fluoropolymers of perfluorodienes, and mixtures thereof.

Suitable amorphous copolymers of tetrafluoroethylene may be chosen among amorphous copolymers of tetrafluoroethylene comprising perfluorinated derivatives of dioxole such as for example 2,2,-bis(trifluoromethyl)-4,5-difluoro-1,3,dioxole or 2,2,4-trifluoro-5-(trifluoromethoxy)-1,3-dioxole. Preferably, the amorphous copolymers of tetrafluoroethylene comprising perfluorinated derivatives of dioxole may have a number average molecular weight Mₙ of from 200 000 to 1 000 000 g/mol, more preferably of form 200 000 to 450 000 g/mol, most preferably of from 200 000 to 300 000 g/mol.

Suitable copolymers of tetrafluoroethylene comprising 2,2,-bis(trifluoromethyl)-4,5-difluoro-1,3,-dioxole may be chosen among amorphous copolymers of tetrafluoroethylene comprising at least 10 mole percent or from 10 to 95 mole percent, more preferably at least 55 mole percent or from than 55 to 95 mole percent of 2,2,-bis(trifluoromethyl)-4,5-difluoro-1,3,dioxole. Suitable copolymers of tetrafluoroethylene comprising 2,2,-bis(trifluoromethyl)-4,5-difluoro-1,3,dioxole are further described in European Patent 0073087, and are commercially obtainable from E. du Pont de Nemours and Company (Wilmington, USA) under the trademark TEFLON® AF.

Suitable copolymers of tetrafluoroethylene comprising 2,2,4-trifluoro-5-(trifluoromethoxy)-1,3-dioxole may be chosen among amorphous copolymers of tetrafluoroethylene comprising at least 10 mole percent or from 10 to 95 mole percent, more preferably at least 55 mole percent or from 55 to 95 mole percent of 2,2,4-trifluoro-5-(trifluoromethoxy)-1,3-dioxole.

Optionally, the copolymers of tetrafluoroethylene comprising 2,2,-bis(trifluoromethyl)-4,5-difluoro-1,3,dioxole or 2,2,4-trifluoro-5-(trifluoromethoxy)-1,3-dioxole may further comprise at least one other ethylenically unsaturated monomer.

Suitable amorphous fluoropolymers of perfluorodienes may be chosen among amorphous fluoropolymers obtainable by cyclopolymerization of linear perfluorodienes and their derivatives, such as for example linear perfluorodienes having a general structure of CF₂═CFO(CF₂)ₙCF═CF₂, wherein n can be of from 2 to 6, and preferably is 2 or 3. More suitable amorphous fluoropolymers obtainable by cyclopolymerization of branched perfluorodienes are described in European Patent 1440961, the disclosure of which is incorporated herein by reference.

The perfluoroalkylether may be chosen among amorphous perfluoroalkylethers, or perfluoroalkyl oils.

Suitable amorphous perfluoroalkylethers may be chosen among amorphous perfluoroalkylethers having a number average molecular weight of at least 500, or of from 500 to 12000, more preferably of at least 4000, or of from 4000 to 12000.

Suitable amorphous perfluoroalkylethers may be chosen among amorphous perfluoroalkylethers comprising repeat units derivable from perfluoroalkene oxides, more preferably repeat units derivable from C2 or C3 perfluoroalkene oxides. For example, suitable amorphous perfluoroalkylethers may be chosen among perfluoroalkylethers comprising repeat units of the formula −CF₂CF₂O—. —CF₂CF₂CF₂O—, —CF(CF₃)CF₂CF₂O—, —CF(CF₃)CF₂O—, —CF₂OCF₂ (CF₃)CF₂O—, —CF₂OCF₂CF₂O—, and/or combinations thereof. Preferably, the amorphous perfluoroalkylethers comprise repeat units of the formula —CF(CF₃)CF₂O—.

For example, a preferred amorphous perfluoroalkylether may have the general structure of: CF₃(CF₂)₂O[CF(CF₃)CF₂O]ₘ—R, where m is of from 2 to 100 and R can be either —CF₂CF₃ or —CF(CF₃)₂.

Suitable amorphous perfluoroalkylethers may be obtained, for example, by anionic polymerization of hexafluoropropylene epoxide as described by Moore in U.S. Pat. No. 3,332,826, the disclosure of which is incorporated herein by reference, and are commercially obtainable from E. L du Pont de Nemours and Company (USA) under the trademark Krytox® GPL.

The fluorinated solvent may be chosen among fluorinated solvents having a boiling point of from 45° C. to 220° C., preferably of from 45° C. to 160° C. or of from 45° C. to 105° C., at atmospheric pressure.

The fluorinated solvent may be chosen among linear, branched, cyclic or heterocyclic (hydro)fluorocarbons, such as for example hydrofluoroalkanes or perfluoroalkanes having the general structure of: CₙF₍₂ₙ₊₂₋ₘ₎Hₘ, where n can be an integer of from 5 to 12 and more preferably of from 5 to 9, and where m can be of from 0 to 3 and preferably is 0.

For example, the fluorinated solvent may be chosen among CF₃CF₂CF₂CF₂CF₃, CF₃CF₂CF₂CF₂CF₂CF₃, CF₃CF₂CF₂CF₂CF₂CF₂CF₃, CF₃CHFCHFCF₂CF₃, CF₃CH₂CHFCF₂CF₃, CF₃CHFCH₂CF₂CF₃, CF₃CHFCHFCF₂CF₂CF₃, CF₃CH₂CHFCF₂CF₂CF₃, CF₃CHFCH₂CF₂CF₂CF₃, CF₃CF₂CH₂CHFCF₂CF₃, CF₃CF₂CHFCHFCF₂CF₂CF₃, CF₃CHFCHFCF₂CF₂CF₂CF₃, CF₃CHFCH₂CF₂CF₂CF₂CF₃, CF₃CH₂CHFCF₂CF₂CF₂CF₃, CF₃CF₂CHFCH₂CF₂CF₂CF₃, CF₃CF₂CH₂CHFCF₂CF₂CF₃, and/or mixtures thereof.

More preferably, the fluorinated solvent may be chosen among (perfluoroalkyl)perfluorotetrahydrofuranes, preferably among those having a perfluoroalkyl moiety having from one 1 to 10 carbon atoms, such as for example 2,2,3,3,4,4,5-heptafluoro-5-(1,1,2,2,3,3,4,4,4-nonafluorobutyl)tetrahydrofuran; or among tri(perfluoroalkyl)amines, preferably among those having a perfluoroalkyl moiety having from 1 to 10 carbon atoms, such as for example tri(perfluoropentyl)amine or tri(perfluorobutyl)amine; or among N-(perfluoroalkyl)morpholines, preferably the ones having a perfluoroalkyl moiety having from 1 to 10 carbon atoms, such as for example N-(perfluoromethyl)morpholine.

Suitable fluorinated solvents may be obtained, for example, by the reduction of polyfluoroolefin starting materials, as described by Krespan in U.S. Pat. No. 6,506,950, the disclosure of which is incorporated herein by reference, and are commercially obtainable from E. I. du Pont de Nemours and Company (USA) under the trademark Vertrel®.

The liquid composition for repairing the insulating sheath of electrical signal-carrying cables according to the present invention may be obtainable by dissolving an amount of amorphous fluoropolymer in the fluorinated solvent, optionally under agitation and/or heating, and subsequently dissolving the perfluoroalkylether in the fluorinated solvent solution of amorphous polymer to form the liquid composition according to the present invention.

The liquid composition for repairing the insulating sheath of electrical signal-carrying cables according to the present invention may further comprise from 1 to 30 weight percent of at least one non-fibrillating polytetrafluoroethylene (PTFE), the weight percentages being based one the total weight of the composition.

The non-fibrillating polytetrafluoroethylene (PTFE) is preferably present in the form of a particulate material having an average particle size of from 1 to 50 μm, more preferably of from 1 to 25 μm when measured according to standard ASTM D4464.

Such non-fibrillating polytetrafluoroethylene (PTFE) are co only available under the designation “PTFE Micro Powder”.

Non-fibrillating polytetrafluoroethylene (PTFE) grades are commercially obtainable from E. I. du Pont de Nemours and Company (USA) under the trademark Zonyl®.

The liquid composition for repairing the insulating sheath of electrical signal-carrying cables according to the present invention may be further useful in the manufacture of novel electrical signal-carrying cables comprising an electrical insulation sheath comprising the liquid composition as described above.

The present invention further provides for a process for repairing an electrically insulating sheath of an electrical signal-carrying cable, comprising the steps of, in this order:

a. depositing a liquid composition comprising at least one amorphous fluoropolymer, at least one amorphous perfluoroalkylether and at least one fluorinated solvent, on at least a damaged area of the electrically insulating sheath to form at least one layer of liquid composition

b. evaporating the fluorinated solvent to solidify the liquid composition.

In the process according to the present invention, the liquid composition may be deposited to the at least a damaged area of an electrically insulating sheath of an electrical signal-carrying cable by coating, spraying, or any suitable method for delivering a liquid to a surface, such as for example with a brush, spatula, an aerosol dispensing pressurized container, atomizer or vaporizer.

In the process according to the present invention, the fluorinated solvent of the liquid composition may be evaporated by any suitable means to solidify the liquid composition, such as for example drying with or without heating, or exposing the liquid composition to vacuum or radiation such as IR, UV or microwave radiation. The thus formed coating restores the electrical insulation of the electrical signal-carrying cable.

In a preferred embodiment, the present invention further provides for a process for repairing an electrically insulating sheath of an electrical signal-carrying cable, comprising the steps of, in this order, depositing a liquid composition according to the above description, on at least a damaged area of the electrically insulating sheath to form at least one layer of liquid composition thereon, then depositing at least one layer of unsintered polytetrafluoroethylene (PTFE) on at least the damaged area of the electrically insulating sheath, and evaporating the fluorinated solvent to solidify the liquid composition.

In an alternative preferred embodiment, the present invention further provides for a process for repairing an electrically insulating sheath of an electrical signal-carrying cable, comprising the steps of, in this order, depositing a liquid composition according to the above description on at least one layer of unsintered polytetrafluoroethylene (PTFE) to form an at least one layer of coated, unsintered polytetrafluoroethylene (PTFE), then depositing the at least one of layer of coated, unsintered polytetrafluoroethylene (PTFE) obtained previously on at least the damaged area of the electrically insulating sheath, and evaporating the fluorinated solvent to solidify the liquid composition.

The at least one layer of unsintered polytetrafluoroethylene (PTFE) can be deposited by winding, preferably in a helical manner, the at least one layer of unsintered polytetrafluoroethylene (PTFE) around the damaged area of the electrical signal-carrying cable. Optionally, a knot may be formed in the at least one layer of unsintered polytetrafluoroethylene (PTFE) to further affix it to the cable.

The at least one layer of unsintered polytetrafluoroethylene (PTFE) suitable in the above preferred processes may be in the form of a film, tape or preformed coil of unsintered polytetrafluoroethylene (PTFE).

The at least one layer of unsintered polytetrafluoroethylene (PTFE) suitable in the above preferred processes may have a thickness of from a 0.025 to 1 mm, preferably of from 0.025 to 0.51 mm or from 0.1 to 0.5 mm.

Polytetrafluoroethylenes that may be used for obtaining the at least one layer of unsintered polytetrafluoroethylene (PTFE) are advantageously chosen among polytetrafluoroethylenes having a propensity to fibrillate and form a fibrous matrix, preferably among those defined under ASTM D 4895.

Polytetrafluoroethylenes (PTFE) that may be used for obtaining the at least one layer of unsintered polytetrafluoroethylene (PTFE) may be chosen among polytetrafluoroethylenes (PTFE) having a standard specific gravity of from 2.14 to 2.185, more preferably from 2.15 to 2.175, when measured according to ISO 12086-2.

Polytetrafluoroethylenes (PTFE) that may be used for obtaining the at least one layer of unsintered polytetrafluoroethylene (PTFE) are obtainable under the designation of “PTFE fine powders”, i.e. particulate polytetrafluoroethylene (PTFE) having an average diameter of from 100 to 1000 μm, when measured according to ISO 12086-2.

In a further embodiment, the present invention provides for a pre-impregnated unsintered polytetrafluoroethylene (PTFE) tape or film for repairing the insulating sheath of electrical signal-carrying cables, comprising unsintered polytetrafluoroethylene (PTFE) and the liquid composition as described above.

The pre-impregnated unsintered polytetrafluoroethylene (PTFE) tape or film may be obtained either by applying the liquid composition as described above onto a previously obtained unsintered polytetrafluoroethylene (PTFE) tape or film or by extruding a mixture of unsintered polytetrafluoroethylene (PTFE) and liquid composition as described above into a tape or film. The liquid composition is absorbed into the unsintered polytetrafluoroethylene (PTFE) tape or film because of its relatively high porosity.

In the case where the pre-impregnated unsintered polytetrafluoroethylene (PTFE) tape or film is obtained by applying the liquid composition as described above onto a previously obtained unsintered polytetrafluoroethylene (PTFE) tape or film, the application of liquid composition may be achieved by suitable methods such as for example dipping, roll coating, brushing, spraying, and such methods known in the art.

In the case where the pre-impregnated unsintered polytetrafluoroethylene (PTFE) tape or film is obtained by extruding a mixture of unsintered polytetrafluoroethylene (PTFE) and liquid composition, the resulting extrudate is processed into a film or tape of the desired thickness by methods known in the art.

A non-limiting, exemplary method of extrusion is lubricated paste extrusion.

The above described pre-impregnated unsintered polytetrafluoroethylene (PTFE) tape or film for repairing the insulating sheath of electrical signal-carrying cable may be immediately deposited on a damaged area of the electrically insulating sheath of an electrical signal-carrying cable after obtaining it, or may be stored in an air-tight container which prevents the fluorinated solvent to evaporate until needed.

The pre-impregnated unsintered polytetrafluoroethylene (PTFE) tape or film for repairing the insulating sheath of electrical signal-carrying cable may comprise of from 10 to 60 weight percent, preferably of from 40 to 60 weight percent, of unsintered polytetrafluoroethylene (PTFE), and of from 40 to 90 weight percent, preferably of from 40 to 60 weight percent of liquid composition as described above, the weight percentages being based on the total weight of the pre-impregnated unsintered polytetrafluoroethylene (PTFE) tape or film.

The present invention further provides for a process for repairing an electrically insulating sheath of an electrical signal-carrying cable, comprising the steps of, in this order:

a. depositing a pre-impregnated unsintered polytetrafluoroethylene (PTFE) tape or film comprising unsintered polytetrafluoroethylene (PTFE) and the liquid composition as described above, on at least a damaged area of the electrically insulating sheath, and

b. evaporating the fluorinated solvent to solidify the liquid composition.

### EXAMPLES

A first solution of hexafluoropropylene-based perfluoropolyether oil in tri(perfluorobutyl)amine, containing 18 weight percent of hexafluoropropylene-based perfluoropolyether oil was prepared by dissolving the corresponding quantities of perfluoropolyether oil in tri(perfluorobutyl)amine.

A second solution of amorphous copolymer of tetrafluoroethylene and 2,2,-bis(trifluoromethyl)-4,5-difluoro-1,3,dioxole in tri(perfluorobutyl)amine, containing 18 weight percent of the amorphous copolymer was prepared by dissolving the corresponding quantities of amorphous copolymer in tri(perfluorobutyl)amine.

The first solution of hexafluoropropylene-based perfluoropolyether oil and the second solution of amorphous copolymer of tetrafluoroethylene and 2,2,-bis(trifluoromethyl)-4,5-difluoro-1,3,dioxole were combined in 1:1 ratio to yield a liquid composition containing 9 weight percent of hexafluoropropylene-based perfluoropolyether oil and 9 weight percent of amorphous copolymer of tetrafluoroethylene and 2,2,-bis(trifluoromethyl)-4,5-difluoro-1,3,dioxole in 82 weight percent tri(perfluorobutyl)amine.

The thus obtained liquid composition was then deposited on one side of an unsintered polytetrafluoroethylene (PTFE) tape having a width of 32 mm, a thickness of 0.07 mm and a length of 200 mm, with a metal spatula, such as to cover the entire surface of the one side of the tape.

A sample electric cable with an external diameter of 3 mm, having a fluorinated ethylene propylene (FEP) sheath of a thickness of 0.4 mm, was damaged over a length of approximately 10 mm using a razor, such as to expose the inner copper conductor.

The damaged area of the electric cable was then coated with the above-obtained liquid composition by brushing the damaged area, and the area within 40 mm of the damaged area, and then immediately winding the unsintered polytetrafluoroethylene (PTFE) tape around in a spiral, with the coated side of the tape facing the electric cable.

The sample electric cable was then placed in an oven at 50° C. for 24 hours to evaporate the tri(perfluorobutyl)amine of the liquid composition.

In total, 5 samples were prepared as above, and then tested for electrical properties.

Before testing, all 5 samples were prepared by soaking the repaired cable section in a 3 weight percent saline solution of sodium chloride for 12 hours.

The 5 samples were tested to determine the break down voltage of the repaired cable section using a Hypotronic #1417 tester, by submerging the repaired cable section in the 3 weight percent saline solution and applying an increasing voltage through the cable.

The voltage was increased from 0V up to 5 kV at a voltage increase rate of 500V/min. The voltage was maintained for 2 minutes at 5 kV. No failure occurred for any of the 5 samples.

In order to test the temperature resistance of the repaired cables, the 5 samples were placed in an oven set at 200° C.

A first sample of the 5 samples was removed from the oven after 36 hours and the repaired cable section submerged in the 3 weight percent saline solution of sodium chloride for 7 hours.

The sample was then tested to determine the break down voltage of the repaired cable section. The voltage was increased from 0V up to 7 kV at a voltage increase rate of 500V/min. The voltage was maintained for 2 minutes at 7 kV. No failure occurred.

The four remaining samples in the oven were removed from the oven after 168 hours and the repaired cable section submerged in the 3 weight percent saline solution of sodium chloride for 12 hours. The samples were then tested to determine the break down voltage of the repaired cable section. The voltage was increased from 0V up to 7 kV at a voltage increase rate of 500V/min. The voltage was maintained for 2 minutes at 7 kV. No failure occurred in any of the four samples.

1. A liquid composition for repairing the insulating sheath of electrical signal-carrying cables comprising:
a. at least one amorphous fluoropolymer,
b. at least one amorphous perfluoroalkylether, and
c. at least one fluorinated solvent.

2. The composition according to claim 1, wherein the amorphous fluoropolymer is chosen from amorphous copolymers of tetrafluoroethylene, amorphous fluoropolymers of perfluorodienes, and mixtures thereof.

3. The composition according to claim 1, wherein the amorphous fluoropolymer is a copolymer comprising tetrafluoroethylene and perfluorinated derivatives of dioxole.

4. The composition according to claim 1, wherein the amorphous perfluoroalkylether comprises repeat units of the formula —CF₂CF₂O—, —CF₂CF₂CF₂O—, —CF(CF₃)CF₂CF₂O—, —CF(CF₃)CF₂O—, —CF₂OCF₂(CF₃)CF₂O—, —CF₂OCF₂CF₂O—, and/or combinations thereof.

5. The composition according to claim 1, wherein the fluorinated solvent is chosen from fluorinated solvents having a boiling point of from 45° C. to 160° C.

6. The composition according to claim 1 comprising from 1 to 30 weight percent of amorphous fluoropolymer, based on the total weight of the composition.

7. The composition according to claim 1 comprising from 1 to 45 weight percent of amorphous perfluoroalkylether, based on the total weight of the composition.

8. The composition according to claim 1 comprising from 25 to 98 weight percent of fluorinated solvent, based on the total weight of the composition.

9. The composition according to claim 1, comprising from 1 to 30 weight percent of at least one non-fibrillating polytetrafluoroethylene (PTFE).

10. The composition according to claim 9, wherein the polytetrafluoroethylene (PTFE) is in the form of a particulate material.

11. The use of the composition according to claim 1 for repairing an electrically insulating sheath of an electrical signal-carrying cable.

12. A process for repairing an electrically insulating sheath of an electrical signal-carrying cable, comprising:
a. depositing a liquid composition according to claim 1 on at least a damaged area of the electrically insulating sheath to form at least one layer of liquid composition, and
b. evaporating the fluorinated solvent to solidify the liquid composition.

13. A process for repairing an electrically insulating sheath of an electrical signal-carrying cable, comprising:
a. depositing a liquid composition according claim 1 on at least a damaged area of the electrically insulating sheath to form at least one layer of liquid composition thereon,
b. depositing at least one layer of unsintered polytetrafluoroethylene (PTFE) on at least the damaged area of the electrically insulating sheath, and
c. evaporating the fluorinated solvent to solidify the liquid composition.

14. A process for repairing an electrically insulating sheath of an electrical signal-carrying cable, comprising:
a. depositing a liquid composition according to claim 1 on at least one layer of unsintered polytetrafluoroethylene (PTFE) to form an at least one layer of coated, unsintered polytetrafluoroethylene (PTFE),
b. depositing the at least one of layer of coated, unsintered polytetrafluoroethylene (PTFE) on at least the damaged area of the electrically insulating sheath, and
c. evaporating the fluorinated solvent to solidify the liquid composition.

15. A pre-impregnated unsintered polytetrafluoroethylene (PTFE) tape or film for repairing the insulating sheath of electrical signal-carrying cables comprising unsintered polytetrafluoroethylene (PTFE) and a liquid composition according to claim 1.

16. A process for repairing an electrically insulating sheath of an electrical signal-carrying cable, comprising:
a. depositing a pre-impregnated unsintered polytetrafluoroethylene (PTFE) tape or film according to claim 15, on at least a damaged area of the electrically insulating sheath, and
b. evaporating the fluorinated solvent to solidify the liquid composition.
